(19) United States
(12) Patent Application Publication
(10) Pub. No.: US 2009/0150071 A1
(43) Pub. Date: Jun. 11, 2009

(54) ROAD NAVIGATION METHOD

(76) Inventor: Tsai-Yun Chen, Hsin Chu (TW)

Correspondence Address: Dykema Gossett, PLLC, Suite 300 West, 1300 I Street, N.W., Washington, DC, 20005-3306, US

(21) Appl. No.: 11/950,586

(22) Filed: Dec. 5, 2007

(51) Int. Cl. G01C 21/26; G01C 21/34; G01S 5/00

(52) U.S. Cl. 701/209; 701/208; 701/200

(57) ABSTRACT

In a road navigation method, a user's current location is transmitted from the user's handheld electronic device to a remote server according to the user's instruction or via a bidirectional transmission between the handheld electronic device and the remote server; and the remote server generates a reference electronic map from a linked electronic-map website or a built-in electronic map based on the user's current location, and transmits the reference electronic map to the user's handheld electronic device for guiding the user on a road. In this manner, the memory capacity of the handheld electronic device is not occupied by an electronic map, and the user is allowed to timely access to a worldwide electronic map for road navigation without the need of using specific software to analyze the electronic map.

### FIELD OF THE INVENTION

The present invention relates to a road navigation method, and more particularly to a road navigation method that allows a user to timely access to a worldwide electronic map for road navigation without the need of building electronic map data in the user's handheld electronic device.

### BACKGROUND OF THE INVENTION

To use a conventional satellite navigation device, a user has to load related electronic map and analytic software into the user's handheld electronic device, and connects the handheld electronic device to a transceiver, so that the handheld electronic device may utilize the electronic map, the analytic software, and the transceiver to work with an external position tracking apparatus, such as a satellite, and displays electronic map information about a desired location and available routes thereto for the user to successfully reach the desired location.

While the above-described conventional satellite navigation device utilizes the built-in electronic map, the analytic software, and the transceiver to work with the external position tracking apparatus and thereby provides the function of locating a desired place for the user, the built-in electronic map would usually occupy a large memory capacity of the handheld electronic device. Since the built-in electronic map is usually applicable to one single country and must be periodically updated, it often causes confusions and inconveniences to the user. Moreover, electronic maps developed by different firms are not compatible with one another, and the user has to purchase specific analytic software to enable wide application of such electronic maps. In brief, most of the conventional satellite navigation devices are not practical for use.

### SUMMARY OF THE INVENTION

A primary object of the present invention is to provide a road navigation method that allows a user to timely access to a worldwide electronic map for road navigation without the need of building an electronic map in the user's handheld electronic device to occupy the memory capacity thereof, or using specific software to analyze the electronic map.

To achieve the above and other objects, the road navigation method according to a first embodiment of the present invention includes the following steps:
(1) a user is provided with a handheld electronic device, which internally includes a global positioning unit, a first transmission unit, and an analytic unit;
(2) the handheld electronic device localizes the user's current location via the global positioning unit;
(3) the user's current location is transmitted to a remote server via the first transmission unit;
(4) the remote server is made to include a second transmission unit, and is linked to at least one electronic-map website or provided with a built-in electronic map;
(5) a reference electronic map is generated by the remote server from the electronic-map website or the built-in electronic map based on the user's current location;
(6) the reference electronic map is transmitted from the remote server to the handheld electronic device via the second transmission unit;
(7) the reference electronic map is displayed on the handheld electronic device via the analytic unit; and
(8) the user moves toward a desired place with the help of the reference electronic map displayed on the handheld electronic device.

In another embodiment of the present invention, the road navigation method includes the following steps:
(1) a user is provided with a handheld electronic device, which internally includes a first transmission unit and an analytic unit;
(2) the handheld electronic device is automatically linked to a remote server via the first transmission unit;
(3) the remote server is made to include a second transmission unit, and is linked to at least one electronic-map website or provided with a built-in electronic map;
(4) a reference electronic map is generated by the remote server from the electronic-map website or the built-in electronic map;
(5) the reference electronic map is transmitted from the remote server to the handheld electronic device via the second transmission unit;
(6) the reference electronic map is displayed on the handheld electronic device via the analytic unit; and
(7) the user moves toward a desired place with the help of the reference electronic map displayed on the handheld electronic device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block flow diagram showing the steps included in a road navigation method according to a first embodiment of the present invention;

FIG. 2 is a conceptual view showing the implementation of the road navigation method of the present invention;

FIG. 3 is a block flow diagram showing the steps included in a road navigation method according to a second embodiment of the present invention;

FIG. 4 is a block flow diagram showing the steps included in a road navigation method according to a third embodiment of the present invention; and

FIG. 5 is a block flow diagram showing the steps included in a road navigation method according to a fourth embodiment of the present invention.

### DETAILED DESCRIPTION OF THE PREFERRED EMBODIMENTS

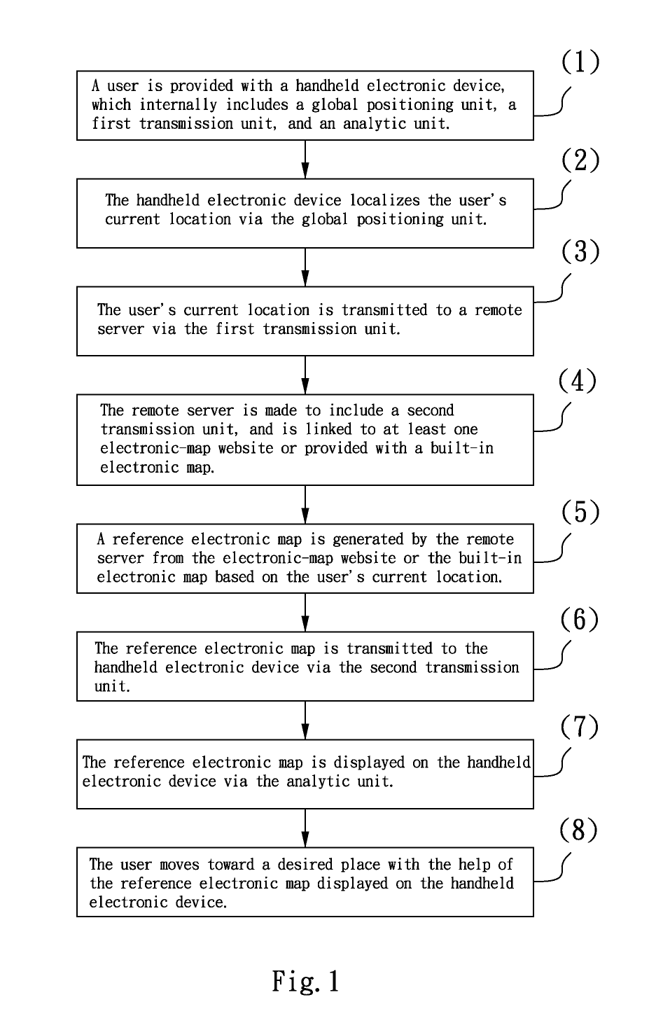

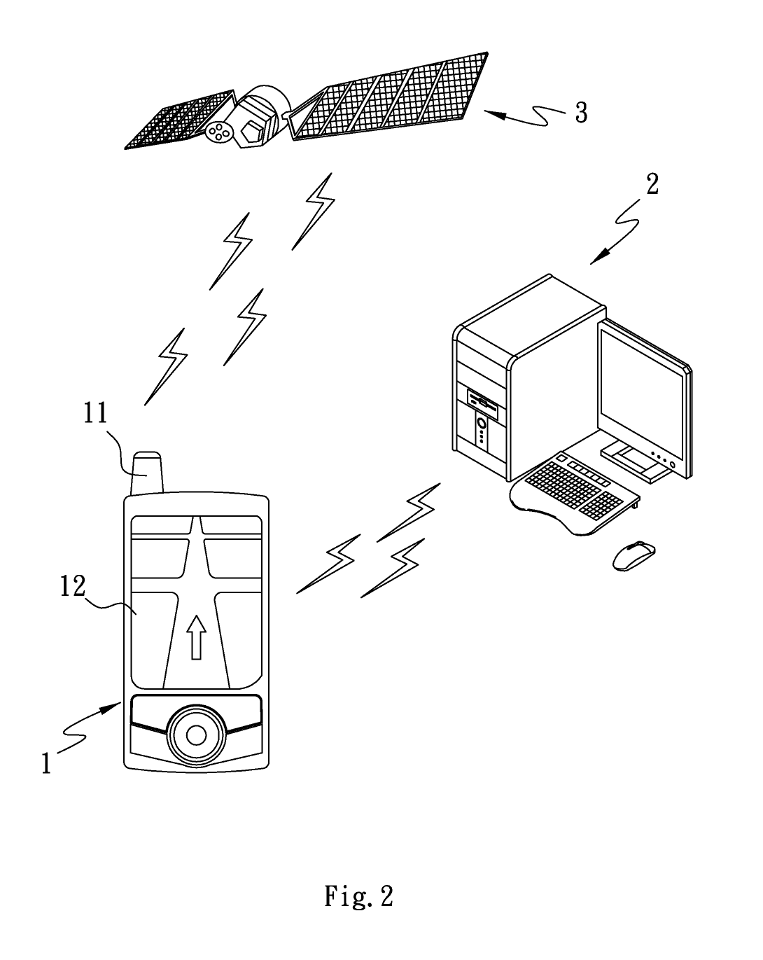

Please refer to FIG. 1 that is a block flow diagram showing the steps included in a road navigation method according to a first embodiment of the present invention, and to FIG. 2 that is a conceptual view showing the implementation of the road navigation method of the present invention. As shown, the road navigation method according to the first embodiment of the present invention includes the following steps:
(1) A user is provided with a handheld electronic device 1, which internally includes a global positioning unit 11, a first transmission unit (not shown), and an analytic unit (not shown);
(2) The handheld electronic device 1 is linked to an external position tracking apparatus 3, such as a satellite, via the global positioning unit 11, so as to localize the user's current location;
(3) The user's current location is transmitted to a remote server 2 via the first transmission unit;
(4) The remote server 2 is made to include a second transmission unit (not shown), and is linked to at least one electronic-map website or provided with a built-in electronic map;
(5) A reference electronic map 12 is generated by the remote server 2 from the electronic-map web site or the built-in electronic map based on the user's current location;
(6) The reference electronic map 12 is transmitted to the handheld electronic device 1 via the second transmission unit;
(7) The reference electronic map 12 is displayed on the handheld electronic device 1 via the analytic unit; and
(8) The user moves toward a desired place with the help of the reference electronic map 12 displayed on the handheld electronic device 1.

Wherein, in the above step (3) the user's current location is transmitted to the remote server 2 via the first transmission unit either through the user's operation on the handheld electronic device 1, or through an automatic operation of the handheld electronic device 1. In other words, the user's current location may be transmitted to the remote server 2 according to the user's instruction or via a bidirectional transmission between the handheld electronic device 1 and the remote server 2. With the road navigation method according to the first embodiment of the present invention, a user may select a place to visit according to the reference electronic map 12.

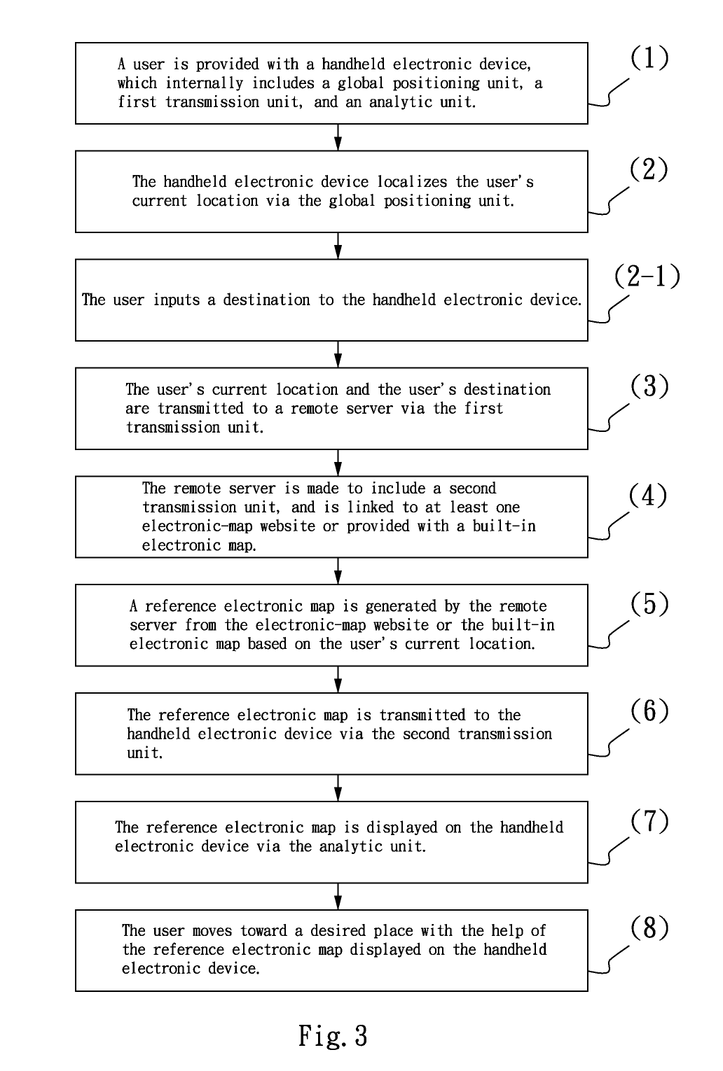

FIG. 3 is a block flow diagram showing the steps included in a road navigation method according to a second embodiment of the present invention. The road navigation method in the second embodiment of the present invention is generally similar to the first embodiment, except that it allows a user to input a destination to the handheld electronic device 1. For this purpose, in the road navigation method according to the second embodiment of the present invention, a step (2-1) is further included between the step (2) and the step (3) in the first embodiment to input a user's destination to the handheld electronic device 1; and, in the step (3), both the user's current location and the user's destination are transmitted to the remote server 2 via the first transmission unit; and, in the step (5), the reference electronic map 12 is generated by the remote server 2 from the electronic-map website or the built-in electronic map based on the user's current location and the user's destination. Again, the user's current location and the user's destination are transmitted to the remote server 2 via the first transmission unit either through the user's operation on the handheld electronic device 1, or through an automatic operation of the handheld electronic device 1. In other words, the user's current location and the user's destination may be transmitted according to the user's instruction or via a bidirectional transmission between the handheld electronic device 1 and the remote server 2. With the road navigation method according to the second embodiment of the present invention, a user may obtain a reference electronic map 12 that shows both the user's current location and the user's destination, and the user may select a route to the destination according to the reference electronic map 12.

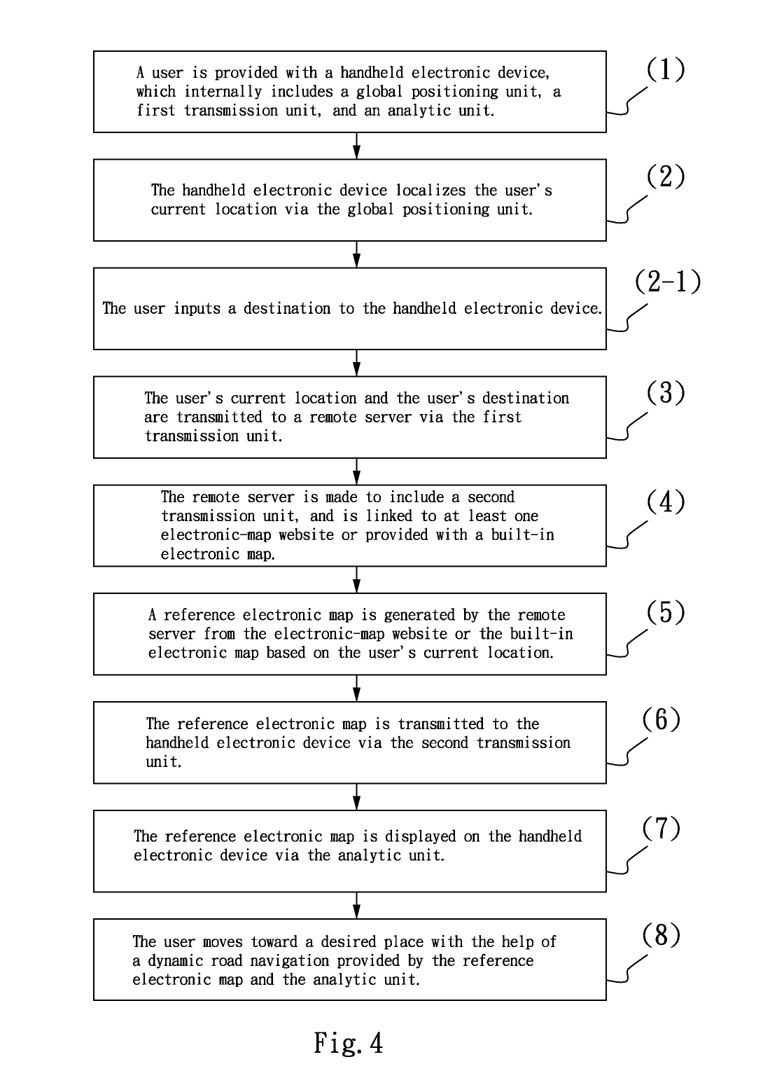

FIG. 4 is a block flow diagram showing the steps included in a road navigation method according to a third embodiment of the present invention. The road navigation method in the third embodiment of the present invention is generally similar to the second embodiment, except that it allows the handheld electronic device 1 to dynamically navigate a user to a destination. For this purpose, the road navigation method in the third embodiment of the present invention includes a step (8) in which the user is dynamically navigated by the reference electronic map 12 and the analytic unit. Again, the user's current location and the user's destination are transmitted to the remote server 2 via the first transmission unit either through the user's operation on the handheld electronic device 1, or through an automatic operation of the handheld electronic device 1. In other words, the user's current location and the user's destination may be transmitted according to the user's instruction or via a bidirectional transmission between the handheld electronic device 1 and the remote server 2. With the road navigation method according to the third embodiment of the present invention, a route from the user's current location to the user's destination is dynamically indicated by the analytic unit, and the user may follow the route dynamically indicated by the analytic unit to reach the destination. As an example, the dynamic road navigation provided by the handheld electronic device 1 may include voice navigation that reminds the user of a distance from the user's current location to the destination or a next turn in the road.

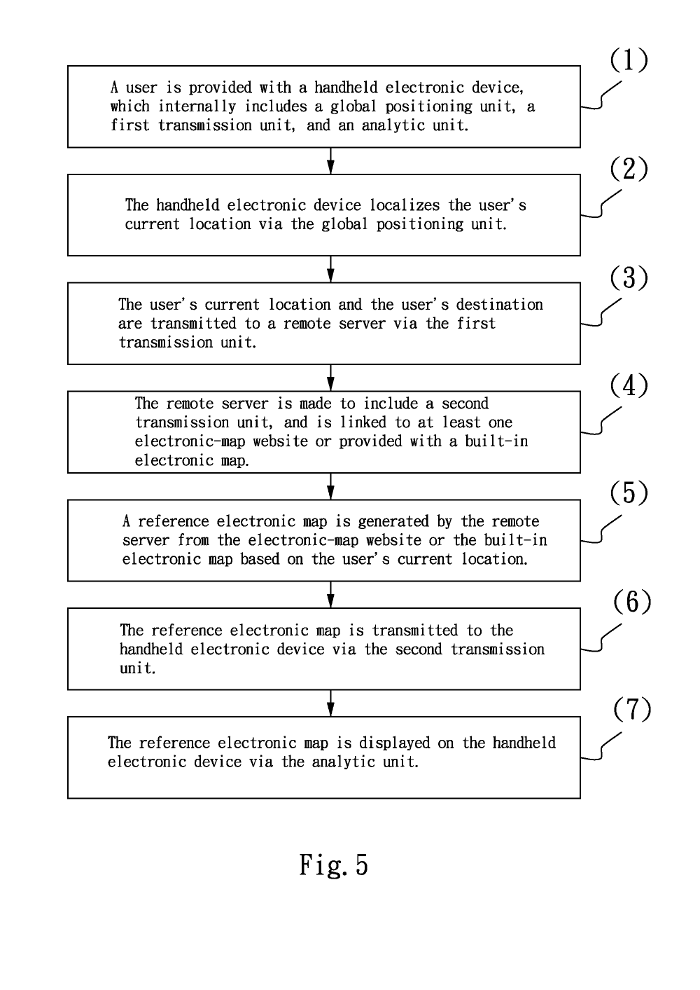

Please refer to FIG. 5 that is a block flow diagram showing the steps included in a road navigation method according to a fourth embodiment of the present invention. As shown, the road navigation method according to the fourth embodiment of the present invention includes the following steps:
(1) A user is provided with a handheld electronic device, which internally includes a first transmission unit and an analytic unit;
(2) The handheld electronic device is automatically linked to a remote server via the first transmission unit;
(3) The remote server is made to include a second transmission unit, and is linked to at least one electronic-map website or provided with a built-in electronic map;
(4) A reference electronic map is generated by the remote server from the electronic-map website or the built-in electronic map;
(5) The reference electronic map is transmitted to the handheld electronic device via the second transmission unit;
(6) The reference electronic map is displayed on the handheld electronic device via the analytic unit; and
(7) The user moves toward a desired place with the help of the reference electronic map displayed on the handheld electronic device.

In the road navigation method according to the fourth embodiment of the present invention, the handheld electronic device is automatically linked to the remote server, and the remote server transmits the reference electronic map back to the handheld electronic device for browsing by the user, so that the user may locate from the reference electronic map a desired zone for road navigation.

In the road navigation method of the present invention, the handheld electronic device may be a cellular phone, a personal digital assistant (PDA), or a notebook computer; the first transmission unit may link to and transmit location data to the remote server via Wireless Fidelity (Wi-Fi), General Packet Radio Service (GPRS), 3^{rd} Generation of Mobile Phone (3G), or High-Speed Downlink Packet Access (HSDPA or 3.5G); and the second transmission unit may transmit the reference electronic map to the handheld electronic device via Wi-Fi, GPRS, 3G, or HSDPA.

The road navigation method of the present invention effectively is superior to the road navigation methods of prior art in that it does not occupy the memory capacity of the user's handheld electronic device, and allows the user to timely access to a worldwide electronic map for road navigation. Moreover, with the road navigation method of the present invention, the user does not need to use specific software for analyzing the electronic map. Therefore, the present invention is improved and practical for use to meet consumers' requirements.

What is claimed is:

1. A road navigation method, comprising the following steps:
(1) a user is provided with a handheld electronic device, which internally includes a global positioning unit, a first transmission unit, and an analytic unit;
(2) the handheld electronic device localizes the user's current location via the global positioning unit;
(3) the user's current location is transmitted to a remote server via the first transmission unit;
(4) the remote server is made to include a second transmission unit, and is linked to at least one electronic-map website or provided with a built-in electronic map;
(5) a reference electronic map is generated by the remote server from the electronic-map website or the built-in electronic map based on the user's current location;
(6) the reference electronic map is transmitted to the handheld electronic device via the second transmission unit;
(7) the reference electronic map is displayed on the handheld electronic device via the analytic unit; and
(8) the user moves toward a desired place with the help of the reference electronic map displayed on the handheld electronic device.

2. The road navigation method as claimed in claim 1, further comprising a step (2-1) of inputting a user's destination to the handheld electronic device after the step (2); and wherein, in the step (3), the input user's destination is transmitted along with the user s current location to the remote server, and, in the step (5), the remote server generates the reference electronic map from the electronic-map website or the built-in electronic map based on the user's current location and the user's destination.

3. The road navigation method as claimed in claim 2, wherein, in the step (8) the user moves toward the desired place with the help of a dynamic road navigation provided by the reference electronic map and the analytic unit.

4. The road navigation method as claimed in claim 1, wherein, in the step (3), the user's current location is transmitted to the remote server via the first transmission unit in a manner selected from the group consisting of a manual operation on the handheld electronic device by the user and an automatic operation of the handheld electronic device.

5. The road navigation method as claimed in claim 2, wherein, in the step (3), the user's current location and the user's destination are transmitted to the remote server via the first transmission unit in a manner selected from the group consisting of a manual operation on the handheld electronic device by the user and an automatic operation of the handheld electronic device.

6. The road navigation method as claimed in claim 3, wherein, in the step (3), the user's current location and the user's destination are transmitted to the remote server via the first transmission unit in a manner selected from the group consisting of a manual operation on the handheld electronic device by the user and an automatic operation of the handheld electronic device.

7. A road navigation method, comprising the following steps:
(1) a user is provided with a handheld electronic device, which internally includes a first transmission unit and an analytic unit;
(2) the handheld electronic device is automatically linked to a remote server via the first transmission unit;
(3) the remote server is made to include a second transmission unit, and is linked to at least one electronic-map website or provided with a built-in electronic map;
(4) a reference electronic map is generated by the remote server from the electronic-map website or the built-in electronic map;
(5) the reference electronic map is transmitted to the handheld electronic device via the second transmission unit;
(6) the reference electronic map is displayed on the handheld electronic device via the analytic unit; and
(7) the user moves toward a desired place with the help of the reference electronic map displayed on the handheld electronic device.

8. The road navigation method as claimed in claim 1, wherein the handheld electronic device is selected from the group consisting of a cellular phone, a PDA, and a notebook computer.

9. The road navigation method as claimed in claim 2, wherein the handheld electronic device is selected from the group consisting of a cellular phone, a PDA, and a notebook computer.

10. The road navigation method as claimed in claim 3, wherein the handheld electronic device is selected from the group consisting of a cellular phone, a PDA, and a notebook computer.

11. The road navigation method as claimed in claim 7, wherein the handheld electronic device is selected from the group consisting of a cellular phone, a PDA, and a notebook computer.

12. The road navigation method as claimed in claim 1, wherein the first transmission unit links to and transmits location data to the remote server via a wireless technology selected from the group consisting of Wireless Fidelity (Wi-Fi), General Packet Radio Service (GPRS), 3^{rd} Generation of Mobile Phone (3G), or High-Speed Downlink Packet Access (HSDPA or 3.5G).

13. The road navigation method as claimed in claim 2, wherein the first transmission unit links to and transmits location data to the remote server via a wireless technology selected from the group consisting of Wireless Fidelity (Wi-Fi), General Packet Radio Service (GPRS), 3^{rd} Generation of Mobile Phone (3G), or High-Speed Downlink Packet Access (HSDPA or 3.5G).

14. The road navigation method as claimed in claim 3, wherein the first transmission unit links to and transmits location data to the remote server via a wireless technology selected from the group consisting of Wireless Fidelity (Wi-Fi), General Packet Radio Service (GPRS), 3^{rd} Generation of Mobile Phone (3G), or High-Speed Downlink Packet Access (HSDPA or 3.5G)

15. The road navigation method as claimed in claim 7, wherein the first transmission unit links to and transmits location data to the remote server via a wireless technology selected from the group consisting of Wireless Fidelity (Wi-Fi), General Packet Radio Service (GPRS), 3^{rd} Generation of Mobile Phone (3G), or High-Speed Downlink Packet Access (HSDPA or 3.5G).

16. The road navigation method as claimed in claim 1, wherein the second transmission unit transmits the reference electronic map to the handheld electronic device via a wireless technology selected from the group consisting of Wireless Fidelity (Wi-Fi), General Packet Radio Service (GPRS), 3^{rd} Generation of Mobile Phone (3G) or High-Speed Downlink Packet Access (HSDPA or 3.5G).

17. The road navigation method as claimed in claim 2, wherein the second transmission unit transmits the reference electronic map to the handheld electronic device via a wireless technology selected from the group consisting of Wireless Fidelity (Wi-Fi), General Packet Radio Service (GPRS), 3^{rd} Generation of Mobile Phone (3G), or High-Speed Downlink Packet Access (HSDPA or 3.5G).

18. The road navigation method as claimed in claim 3, wherein the second transmission unit transmits the reference electronic map to the handheld electronic device via a wireless technology selected from the group consisting of Wireless Fidelity (Wi-Fi), General Packet Radio Service (GPRS), 3^{rd} Generation of Mobile Phone (3G), or High-Speed Downlink Packet Access (HSDPA or 3.5G).

19. The road navigation method as claimed in claim 7, wherein the second transmission unit transmits the reference electronic map to the handheld electronic device via a wireless technology selected from the group consisting of Wireless Fidelity (Wi-Fi), General Packet Radio Service (GPRS), 3^{rd} Generation of Mobile Phone (3G), or High-Speed Downlink Packet Access (HSDPA or 3.5G).
